(19) United States
(12) Patent Application Publication
(10) Pub. No.: US 2023/0151837 A1
(43) Pub. Date: May 18, 2023

(54) RELEASABLE MOUNTING DEVICE

(71) Applicant: NUCAP INDUSTRIES INC., Toronto (CA)

(72) Inventor: Roman ARBESMAN, Toronto, Ontario (CA)

(21) Appl. No.: 17/905,633

(22) PCT Filed: Mar. 3, 2021
(86) PCT No.: PCT/CA2021/050278

§ 371 Date: Sep. 3, 2022

Related U.S. Application Data
(60) Provisional application No. 62/985,412, filed on Mar. 5, 2020.

(51) Int. Cl. F16B 5/07; A47G 1/16; A44B 18/00; F16B 37/04

(52) U.S. Cl. CPC F16B 5/07; A44B 18/0073; A47G 1/1606; F16B 37/041; F16B 2001/0028

(57) ABSTRACT

A releasable mounting device for supporting an article including a metal sheet having a front surface, a rear surface opposite the front surface, and a side edge extending between the front surface and the rear surface. At least a first hole extends through the sheet from the front surface to the rear surface. Hooked barbs extend integrally from the top surface, and grooves formed in the top surface. Each hooked barb is associated with a respective one of the grooves.

### PRIORITY CLAIM

This patent application is a U.S. National Phase of International Patent Application No. PCT/CA2021/050278, filed 3 Mar. 2021, which claims priority to U.S. Provisional Pat. Application No. 62/985,412, filed 5 Mar. 2020, the disclosures of which are incorporated herein by reference in their entireties.

### FIELD

This document relates to apparatuses for supporting articles. More specifically, this document relates to releasable mounting devices for supporting articles on a vertical surface.

### SUMMARY

The following summary is intended to introduce the reader to various facets of the detailed description, but not to define or delimit any exemplary embodiments.

Releasable mounting devices for supporting articles are disclosed. According to some exemplary embodiments, a releasable mounting device includes a metal sheet having a rear surface, a front surface opposite the rear surface, and a side edge extending between the front surface and the rear surface. At least a first hole extends through the sheet from the front surface to the rear surface. A plurality of hooked barbs extend integrally from the front surface, and a plurality of grooves are formed in the front surface. Each hooked barb is associated with a respective one of the grooves.

In some examples, the front surface includes a recess, and the hole is defined between the recess and the rear surface. The recess can be free of hooked barbs. The rear surface can include a protrusion that is opposite the recess, and the hole can be defined between the recess and the protrusion.

In some examples, the metal sheet is in the shape of a circle. The hole can be positioned centrally on the metal sheet.

The mounting device can further include a fastener for passage through the hole to mount the metal sheet to a surface.

Vertical surface-mounted assemblies are also disclosed. According to some exemplary embodiments, a vertical surface-mounted assembly includes a releasable mounting device including a metal sheet having a rear surface that is in abutment with a vertical surface, a front surface opposite the rear surface, and a side edge extending between the front surface and the rear surface. At least a first hole extends through the sheet from the front surface to the rear surface. A plurality of hooked barbs extends integrally from the front surface, and a plurality of grooves is formed in the rear surface. Each hooked barb is associated with a respective one of the grooves. The assembly further includes a fastener having a head and a threaded shaft. The threaded shaft extends through the hole and is embedded in the vertical surface, and the head abuts the front surface. The assembly further includes an article having a loop fastener device secured thereto. The loop fastener device includes a plurality of loops. The barbed hooks are releasably secured in the loops to releasably secure the article to the vertical surface.

In some examples, the front surface includes a recess and the hole is defined between the recess and the rear surface. The head can be nested in the recess. The recess can be free of hooked barbs. The rear surface can include a protrusion that is opposite the recess, and the hole can be defined between the recess and the protrusion. The protrusion can be in abutment with the vertical surface.

In some examples, the loop fastener device includes a base sheet supporting the plurality of loops. The base sheet and loops can be polymeric.

Methods for supporting an article on a vertical surface are also disclosed. According to some exemplary embodiments, a method of supporting an article on a vertical surface includes a. positioning a rear surface of a metal sheet against a vertical surface; b. fastening the metal sheet to the vertical surface; c. securing a loop fastener device to an article; and d. positioning the loop fastener adjacent a front surface of the metal sheet and hooking barbed hooks of the front surface into loops of the loop fastener device.

In some examples, step b. includes passing a threaded shaft of a fastener through a hole of the metal sheet. Step b. can further include nesting a head of the fastener in a recess of the front surface.

In some examples, step b. includes fastening the metal sheet to the vertical surface centrally on the metal sheet.

In some examples, step a. includes positioning a protrusion of the rear surface against the vertical surface.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a front view of an example releasable mounting device;

FIG. 2 is a rear view of the releasable mounting device of FIG. 1;

FIG. 3 is a perspective view of the releasable mounting device of FIG. 1;

FIG. 4 is an enlarged partial front view of the releasable mounting device of FIG. 1;

FIG. 5 is a cross-sectional view taken along A-A in FIG. 1;

FIG. 6 is a partial side view of the releasable mounting device of FIG. 1; and

FIG. 7 shows an article supported by the releasable mounting device.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

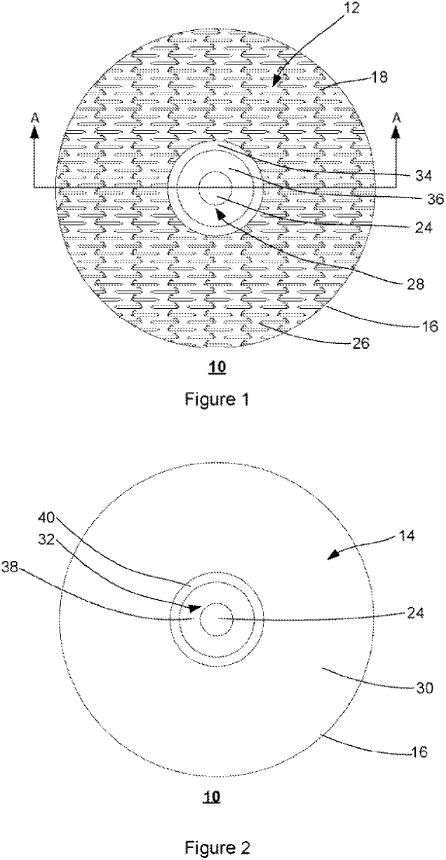

Referring to FIGS. 1 and 2, a releasable mounting device 10 for supporting articles is shown. The releasable mounting device 10 includes a metal sheet having a front surface 12, a rear surface 14 opposite the front surface 12, and a side edge 16 extending between the front surface 12 and rear surface 14. In the example shown, the metal sheet is generally circular; however, other shapes are possible, such as rectangular strips. The metal sheet can be formed by stamping, and can be made from a flat, light-weight metal, such as steel, stainless steel, aluminum, copper, brass and bronze.

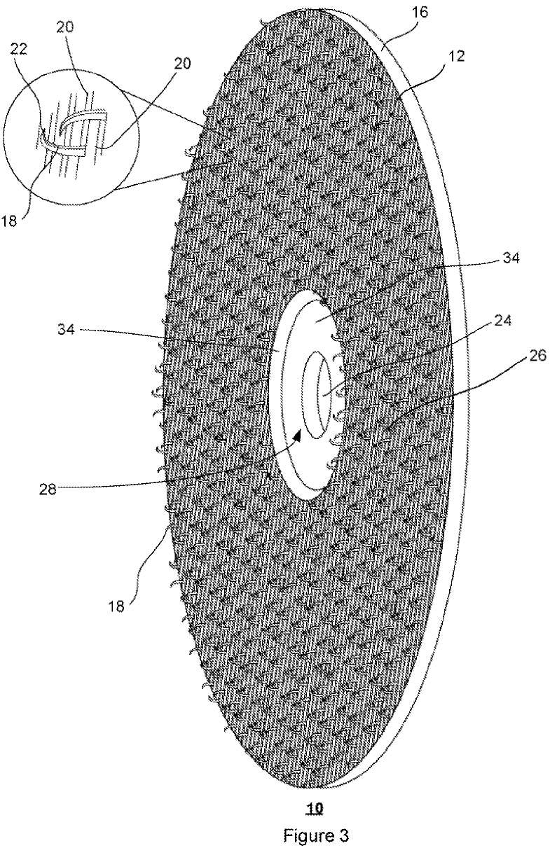

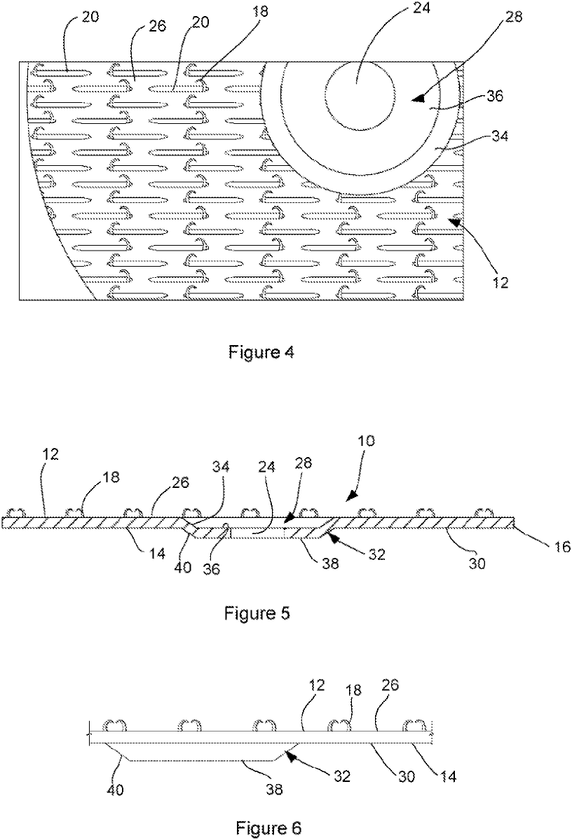

Referring to FIGS. 3 and 4, a plurality of hooked barbs 18 extend integrally from the front surface 12. The hooked barbs 18 can be, for example, gouged into the metal sheet using a process as described in U.S. Pat. No. 9,463,502 (Arbesman et al.). This gouging process can leave a plurality of grooves 20 formed in the front surface 12, where material is removed to form the barbs 18. Each groove 20 is associated with a respective one of the barbs 18. In the example shown, each hooked barb has a pointed tip 22. The hooked barbs 18 can have a height of, for example, between 0.010 inches to 0.125 inches (as measured from the front surface 12). The hooked barbs 18 and grooves 20 can optionally be arranged in rows, which can be parallel. Optionally, all hooked barbs 18 within a given row can be pointed in one direction, and all hooked barbs 18 in an adjacent row can be pointed in the opposite direction. Optionally, the hooked barbs 18 can be of different heights, and can be hooked to different degrees. This can allow for more firm attachment to a loop fastener device (described below)

Referring to FIG. 5, a hole 24 extends through the metal sheet, from the front surface 12 to the rear surface 14. The hole 24 can receive a fastener, such as a screw as described below, to secure the metal sheet to a vertical surface such as a wall. In the example shown, the hole 24 is positioned centrally on the metal sheet.

Referring to FIGS. 5 and 6, in the example shown, the front surface 12 includes a generally flat periphery 26 and a centrally positioned recess 28, and the rear surface 14 includes a generally flat periphery 30 and a protrusion 32 opposite the recess 28. The recess 28 includes an angled annular wall 34 and a flat base portion 36. The protrusion 32 also includes a flat base portion 38, which is opposite the flat base portion 36 of the recess, and an angled annular wall 40.

Referring to FIG. 5, in the example shown, the hole 24 is defined between the recess 28 and the protrusion 32, and the recess 28 provides a space into which a head of fastener can nest. The recess 28 is free of barbs 18.

The releasable mounting device 10 can be used to releasably mount articles to vertical surfaces such as walls, by mating with a loop fastener secured to the article, as will be described below. Such articles can include, for example, household articles and/or tools.

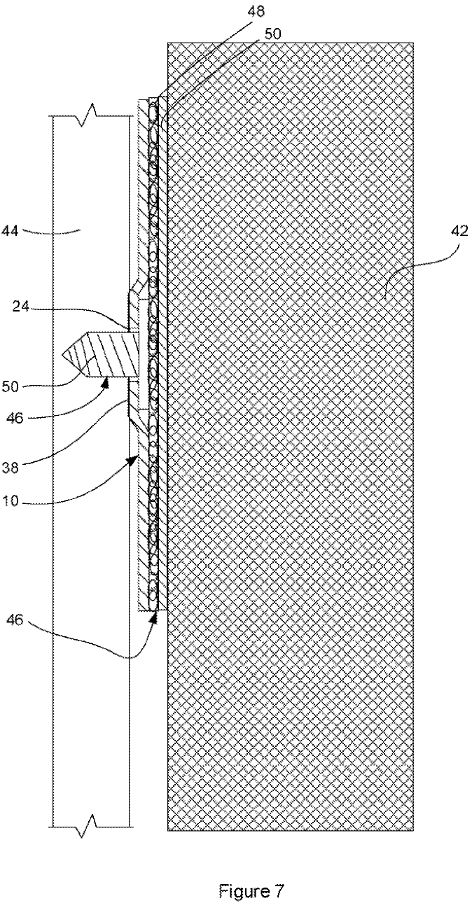

Referring to FIG. 7, an article 42 is shown supported on a wall 44 by the releasable mounting device 10. The article 42 has a loop fastener device 46 secured thereto. The loop fastener device 46 can include a plurality of loops 48 supported by a base sheet 50. The loop fastener device 46 can be made from a different material than the metal sheet; for example, the loop fastener device 46 can be polymeric or can be a textile. In some particular examples, the loop fastener device 46 is a material sold under the brand name Velcro®. The loop fastener device 46 can be secured to the article in any suitable fashion, including using a fastener such as a screw, or using an adhesive.

Referring still to FIG. 7, as a first step for supporting article 42 on wall 44, releasable mounting device 10 is placed against the wall 44 with the flat base portion 38 abutting the wall 44. Next, the metal sheet is fastened to the wall 44, for example, using a fastener 46. The fastener 46 has a head 48 and a threaded shaft 50. The threaded shaft 50 can be passed through the hole. 24 and embedded in the wall 44 until the head 48 is nested in the recess 28 (not labelled in FIG. 7). The head 48 may lay flush with the periphery 26 (not labelled in FIG. 7) of the front surface 12 (not labelled in FIG. 7), allowing for better engagement between releasable mounting device 10 and loop fastener device 10.

The article 42, with the loop fastener device 46 secured thereto, can then be secured to the mounting device 10. The article 42 is lifted and oriented so that the loop fastener device 46 is adjacent the front surface 12 of the metal sheet 10. The loop fastener device 46 can then be pressed into the metal sheet 10, so that the barbed hooks 18 hook into the loops 48 of the loop fastener device 46. This hook-and-loop system can be capable of withstanding substantial shear forces. In one example, this hook-and-loop attachment system is capable of withstanding 175 lbs. The article 42 may be dismounted from the wall 44 by separating the loop fastener device 46 from the releasable mounting device 10, which may accomplished by a lifting and peeling motion of the loop fastener device 46 relative to releasable mounting device 10.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A releasable mounting device for supporting an article, the releasable mounting device comprising:
a metal sheet having a front surface, a rear surface opposite the front surface, and a side edge extending between the front surface and the rear surface;
at least a first hole extending through the sheet from the front surface to the rear surface; and
a plurality of hooked barbs extending integrally from the top surface, and a plurality of grooves formed in the top surface, wherein each hooked barb is associated with a respective one of the grooves.

2. The releasable mounting device of claim 1, wherein the front surface comprises a recess, and the hole is defined between the recess and the rear surface.

3. The releasable mounting device of claim 1, wherein the recess is free of hooked barbs.

4. The releasable mounting device of claim 2 , wherein the rear surface comprises a protrusion that is opposite the recess.

5. The releasable mounting device of claim 4, wherein the hole is defined between the recess and the protrusion.

6. The releasable mounting device of claim 1, wherein the metal sheet is in the shape of a circle.

7. The releasable mounting device of claim 1, wherein the hole is positioned centrally on the metal sheet.

8. The releasable mounting device of claim 1, further comprising a fastener for passage through the hole to mount the metal sheet to a surface.

9. A vertical surface-mounted assembly, comprising:
a releasable mounting device comprising a metal sheet having a rear surface that is in abutment with a vertical surface, a front surface opposite the rear surface, a side edge extending between the front surface and the rear surface, at least a first hole extending through the sheet from the front surface to the rear surface, a plurality of hooked barbs extending integrally from the top surface, and a plurality of grooves formed in the top surface, wherein each hooked barb is associated with a respective one of the grooves;
a fastener having a head and a threaded shaft, the threaded shaft extending through the hole and embedded in the vertical surface, and the head abutting the front surface; and
an article having a loop fastener device secured thereto, the loop fastener device comprising a plurality of loops, wherein the barbed hooks are releasably secured in the loops to releasably secure the article to the vertical surface.

10. The vertical surface-mounted assembly of claim 9, wherein the front surface comprises a recess and the hole is defined in the recess, and wherein the head is nested in the recess.

11. The vertical surface-mounted assembly of claim 10, wherein the recess is free of hooked barbs.

12. The vertical surface-mounted assembly of claim 10, wherein the rear surface comprises a protrusion that is opposite the recess, and the protrusion is in abutment with the vertical surface.

13. The vertical surface-mounted assembly of claim 9, wherein the loop fastener device comprises a base sheet supporting the plurality of loops, and wherein the base sheet and loops are polymeric.

14. The vertical surface-mounted assembly of claim 9, wherein the barbed hooks in engagement with the loops are capable of withstanding substantial shear forces.

15. A method of supporting an article on a vertical surface, the method comprising:
a. positioning a rear surface of a metal sheet against a vertical surface;
b. fastening the metal sheet to the vertical surface;
c. securing a loop fastener device to an article; and
d. positioning the loop fastener adjacent a front surface of the metal sheet and hooking barbed hooks of the front surface into loops of the loop fastener device.

16. The method of claim 15, wherein step b. comprises passing a threaded shaft of a fastener through a hole of the metal sheet.

17. The method of claim 16, wherein step b. further comprises nesting a head of the fastener in a recess of the front surface.

18. The method of claim 15, wherein step b. centrally fastens the metal sheet to the vertical surface.

19. The method of claim 15, wherein step a. comprises positioning a protrusion of the rear surface against the vertical surface.

20. A releasable mounting device for supporting an article, the releasable mounting device comprising:
a sheet;
at least one hole extending through the sheet; and
a plurality of hooked barbs extending integrally a surface of the sheet, and a plurality of grooves formed in the surface, wherein each hooked barb is associated with a respective one of the grooves.

21. The releasable mounting device of claim 20, wherein the sheet is metal.

22. The releasable mounting device of claim 20, further comprising a fastener for passage through the hole to mount the sheet to a surface.
